(19) United States
(12) Patent Application Publication
(10) Pub. No.: US 2015/0293600 A1
(43) Pub. Date: Oct. 15, 2015

(54) DEPTH-BASED ANALYSIS OF PHYSICAL WORKSPACES

(71) Applicant: Visual Exploration LLC, Boulder, CO (US)

(72) Inventor: James Thomas Sears, Boulder, CO (US)

(21) Appl. No.: 14/683,649

(22) Filed: Apr. 10, 2015

Related U.S. Application Data
(60) Provisional application No. 61/995,489, filed on Apr. 11, 2014.

(51) Int. Cl. G06F 3/01; H04N 13/02; G06T 7/00

(52) U.S. Cl. CPC G06F 3/017; G06T 7/0075; G06T 7/0079; H04N 13/0271

(57) ABSTRACT

Systems and methods are provided for dynamically performing depth-based analysis of a physical workspace. The system includes a depth camera to generate three dimensional (3D) images, and a controller. The controller is able to acquire a stream of 3D images, calculate distances between the depth camera and objects represented by 3D pixels within the 3D images, identify an increase in distance between the objects and the depth camera, detect a pause, and define a reference surface during the pause. The controller is also able to identify a change in distance between the objects and the depth camera after defining the reference surface, to identify a segment of the current 3D image close to the depth camera, and to determine a gesture location within the current 3D image based on the identified segment. A data set corresponding to the gesture location then adjusts an output of a display.

### RELATED APPLICATIONS

This application claims priority to provisional application No. 61/995,489, titled “DATABASE EXPLORATION AND VISUAL MAGNIFICATION USING DEPTH CAMERA SENSING OF POINTER IN RELATION TO REFERENCE SURFACE TO CONTROL OBSERVATIONAL VIEWPOINT,” filed on Apr. 11, 2014, and herein incorporated by reference.

### FIELD OF THE INVENTION

The invention relates to the field of imaging, and in particular, to analyzing gesture input from a user in a physical workspace.

### BACKGROUND

Proprioception relates to a person's innate sense of the relative position of his or her body parts with respect to the surroundings. For example, proprioception may allow a person to infer the location of her hand or arm while her eyes are closed, based on sensory feedback indicating the tension of certain muscles. Devices that utilize proprioception are desirable to users because they are intuitive to interact with. However, few systems on the market utilize proprioceptive input as part of a user interface. Detecting proprioceptive input remains challenging because users do not wish to wear bulky devices to track their own natural motion, and yet also desire accurate and precise feedback in response to the movements of their bodies. Thus, designers continue to seek out innovative techniques for identifying and resolving proprioceptive input.

### SUMMARY

Embodiments described herein may dynamically detect proprioceptive input from a user by acquiring and analyzing a stream of three dimensional (3D) images of a physical workspace, such as a table or desk. Thus, if a user moves his hand across the workspace, the change in depth of 3D pixels in the 3D image stream may be analyzed to identify the presence of user input (such as a pointing input) within the workspace. Furthermore, embodiments herein may dynamically define a reference surface (e.g., a static environment) in order to detect the presence of user input relative to the reference surface in the 3D image stream.

One embodiment is a system that includes a depth camera able to generate three dimensional (3D) images of a physical workspace, and a controller. The controller is able to acquire a stream of 3D images from the camera, to calculate distances between the depth camera and objects within the physical workspace that are represented by 3D pixels within the 3D images of the stream, to identify an increase in distance between the objects and the depth camera over time, to detect a pause following the increase in distance, and to define a reference surface corresponding to a 3D image of the physical workspace during the pause. The controller is also able to identify a change in distance between the objects and the depth camera for a current 3D image acquired after defining the reference surface, to identify a segment of the current 3D image that is closer to the depth camera than the reference surface, and to determine a gesture location within the current 3D image based on the identified segment. Additionally, the controller is able to identify a data set corresponding to the gesture location, and adjust an output of a display based on information in the data set.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an imaging system in an exemplary embodiment.

FIG. 2 is a flowchart illustrating a method for operating an imaging system in an exemplary embodiment.

FIG. 3 is a diagram illustrating measurements acquired by a depth camera in an exemplary embodiment.

FIG. 4 is a diagram illustrating a top view of a physical workspace and associated reference surface in an exemplary embodiment.

FIG. 5 is a diagram illustrating a set of 3D pixels representing a physical workspace in an exemplary embodiment.

FIG. 6 is a diagram illustrating a perspective view of a set of 3D pixels representing a physical workspace in an exemplary embodiment.

FIG. 7 is a diagram illustrating a perspective view of a reference surface within a physical workspace in an exemplary embodiment.

FIG. 8 is a flowchart illustrating a method for defining a reference surface in an exemplary embodiment.

FIG. 9 is a further flowchart illustrating a method for defining a reference surface in an exemplary embodiment.

FIG. 10 is a diagram illustrating an imaging system for assisting reading an exemplary embodiment.

FIG. 11 is a diagram illustrating an imaging system for viewing medical scans in an exemplary embodiment.

FIG. 12 is a diagram illustrating an imaging system for presenting network accessible contextual information in an exemplary embodiment.

FIG. 13 is a diagram illustrating a further imaging system for presenting network accessible contextual information in an exemplary embodiment.

FIG. 14 is a diagram illustrating an imaging system implemented on a mobile device in an exemplary embodiment.

FIGS. 15-18 are diagrams illustrating trigger conditions for redefining a reference surface in an exemplary embodiment.

FIG. 19 illustrates a processing system operable to execute a computer readable medium embodying programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

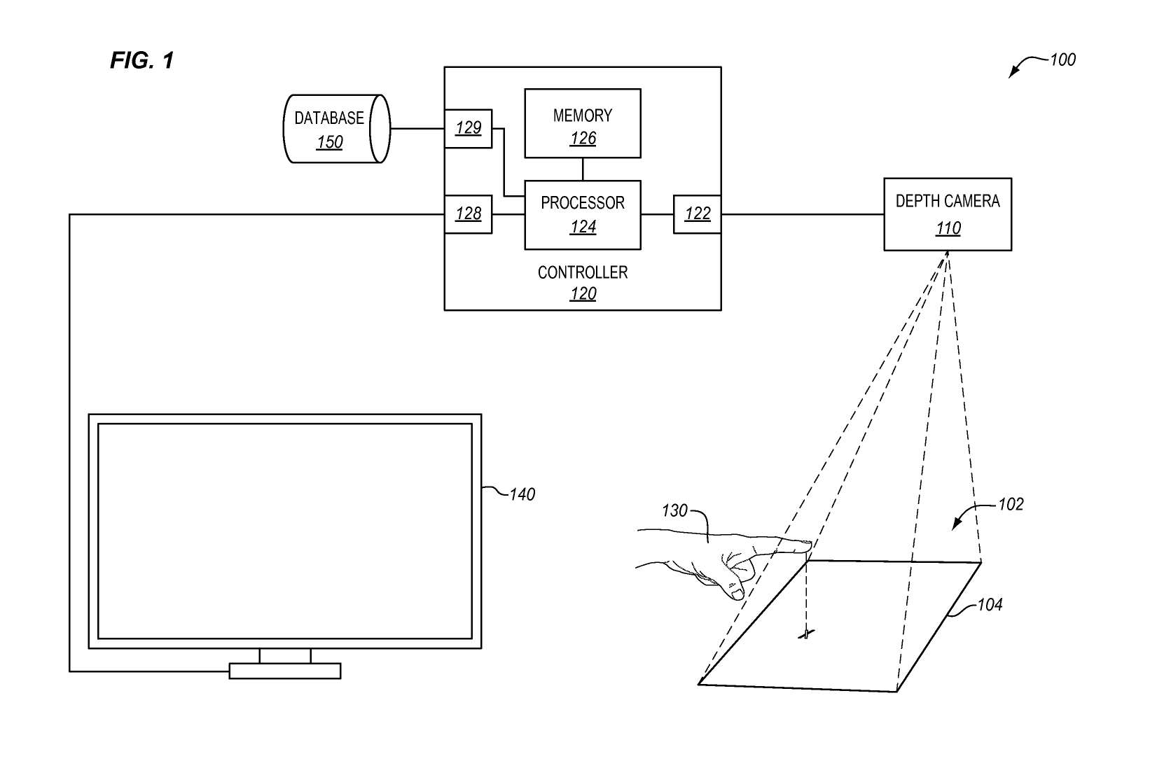

FIG. 1 is a block diagram of an imaging system 100 in an exemplary embodiment. Imaging system 100 comprises any system, device, or component operable to analyze three dimensional (3D) images of a physical workspace 102 in order to detect a user's gestures, and to dynamically modify the output of a display 140 based on those gestures. As used herein, a workspace is a physical volume of space, existing in the real world and capable of including objects such as books, magazines, mugs, a human hand, etc. In this embodiment, the borders of workspace 102 are contiguous with the field of view of depth camera 110 of imaging system 100.

Depth camera 110 generates 3D images that depict workspace 102. That is, each 3D image generated by camera 110 depicts objects within the volume defined by workspace 102. As used herein, a 3D image is any image that includes information for accurately calculating a depth/distance and X/Y information in the form of 3D pixels (e.g., defined as 3D coordinates accompanied by color and/or luminance values, representing voxels, etc.). For example, a 3D image may indicate a depth (e.g., Z) as well as an X and Y coordinate for each 3D pixel shown therein. In this embodiment, each 3D image represents the entirety of workspace 102.

Depth camera 110 comprises any system, component, or device operable to generate the 3D images over time, and may comprise a stereo camera utilizing input from multiple lenses to determine depth, a time of flight camera that utilizes modulated phases of light to detect depth, a pattern distortion camera that projects a pattern onto workspace 102 and detects a distortion of the projected pattern to determine depth, etc. Depth camera 110 is capable of capturing 3D images over time (e.g., at a rate of many frames per second), which in turn enables an enhanced level of responsiveness to user interactions. In one embodiment, depth camera 110 comprises a Raspberry Pi 2 compute module with dual camera channels linked to component 2D cameras that are closely spaced and include an LED between them. A controller may use input from the dual cameras to acquire 3D pixels and images, and may use depth camera 110 to observe workspace 102 in high resolution to track pointing input (e.g., a bright/luminant retro reflective dot) in three dimensions. In this embodiment, the controller may track/acquire 3D pixels for just retro reflective portions of the generated images.

Controller 120 acquires a stream of 3D images from depth camera 110 via interface 122. Controller 120 analyzes 3D images from camera 110 to identify a focal object 130 within workspace 102. Focal object 130 is a physical visual indicator/marker (such as a pen, hand, or finger) that performs gestures for a user.

As used herein, a gesture may indicate a location of a user's interest at a point in time, may correspond with a position or shape indicative of command, or may even be indicated over a series of frames in which the user moves the focal object in a recognizable pattern. To identify a gesture indicated by focal object 130, controller 120 may compare incoming 3D images against a known “reference surface” 104 (e.g., a two dimensional (2D) or 3D surface) depicting a lower, static portion of physical workspace 102. For example, Controller 120 may perform segmenting to detect 3D pixels of an acquired 3D image that are above reference surface 104, and then identify focal object 130 based on the locations of those 3D pixels. Based on gestures provided by focal object 130, controller 120 manipulates the output of display 140 to provide contextual information for the user.

In this embodiment, controller 120 comprises interfaces 122, 128, and 129, processor 124, and memory 126. Interfaces 122, 128, and 129 comprise any suitable interfaces for exchanging data, such as a Camera Serial Interface Type 2 (CSI-2) interface, a High-Definition Multimedia Interface (HDMI), a computer bus, a Universal Serial Bus (USB) interface, a wireless adapter in accordance with Institute of Electrical and Electronics Engineers (IEEE) 802.11 standards, etc. Processor 124 accesses instructions stored in memory 126 (e.g., Random Access Memory (RAM) or a flash memory) in order to process user input within workspace 102 and control the output of display 140. Processor 124 may be implemented as custom circuitry, a general-purpose processor executing programmed instructions, etc.

Controller 120 accesses database 150 via interface 129, and accesses display 140 via interface 128. In this embodiment database 150 includes information for presentation at display 140. For example, database 150 may include a set of entries describing tomographic slices of medical imaging data, a cut-away high-resolution image or portion of an image, or other information as described below with respect to the examples. Database 150 may be stored locally on the same device as controller 120, or may be a network-accessible database accessed by controller 120 as well as multiple other imaging systems. Display 140 comprises a digital presentation device such as a projector, a flat screen monitor, or a mobile device (e.g., a tablet or phone) screen. In one embodiment, camera 110, controller 120, and display 140 are all integrated into a single mobile device, such as a smart phone or tablet.

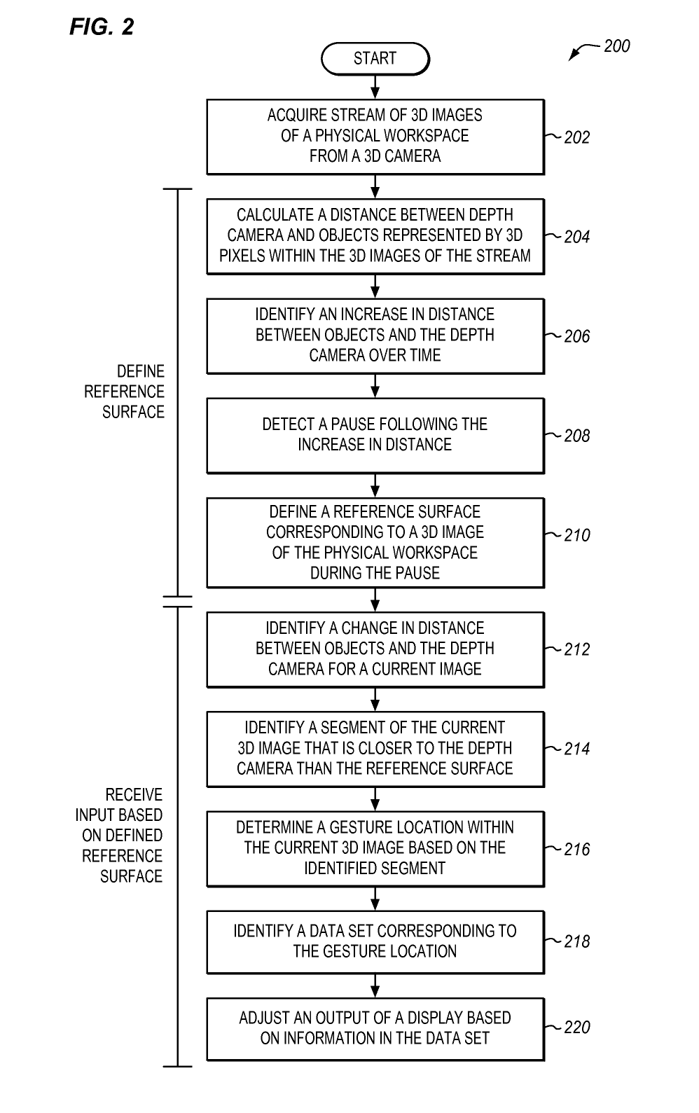

Because imaging system 100 utilizes 3D image processing to detect input in a physical workspace 102, a user may use proprioception to guide the operations of imaging system 100 quickly and accurately using a finger or hand. The particular arrangement, number, and configuration of components described herein is exemplary and non-limiting. Illustrative details of the operation of imaging system 100 will be discussed with regard to FIG. 2. Assume, for this embodiment, that a user has just turned on imaging system 100 in order interact with workspace 102. Further, assume that the user is moving focal object 130 (e.g., a pen, wand, or finger tip) within workspace 102 to direct the operations of imaging system 100.

FIG. 2 is a flowchart illustrating a method 200 for operating an imaging system in an exemplary embodiment. The steps of method 200 are described with reference to imaging system 100 of FIG. 1, but those skilled in the art will appreciate that method 200 may be performed in other systems as desired. The steps of the flowcharts described herein are not all inclusive and may include other steps not shown. The steps described herein may also be performed in an alternative order.

In step 202, controller 120 acquires a stream of 3D images of physical workspace 102 from depth camera 110. Each 3D image depicts the field of view of depth camera 110. Furthermore, each 3D image includes information in the form of 3D pixels indicating distances/depths from depth camera 110 to objects within (e.g., portions of) workspace 102. Each 3D image defines multiple 3D pixels that each are associated with an X position, a Y position, and a Z position indicating depth. As used herein, a “depth” refers to a distance from the depth camera to a portion of the workspace, while a “height” refers to an elevation either above (closer to the camera than) or below (further away from the camera than) a predefined level. Controller 120 may acquire the stream of 3D images periodically (e.g., once every second) and/or in real time (e.g., at a rate of multiple frames per second).

As controller 120 acquires the stream of 3D images, controller 120 may utilize two ongoing processes shown in method 200 for handling the stream of 3D images. The first process, shown in steps 204-210, is an initialization/re-initialization process where a reference surface is defined for workspace 102. In the second process, shown in steps 212-220, gestures from a user are detected within the physical workspace by comparing newly acquired 3D images against the presently defined reference surface. These processes may continue substantially in parallel and asynchronously while imaging system 100 is operating. The steps are provided in the sequence below to illustrate an exemplary order of operation.

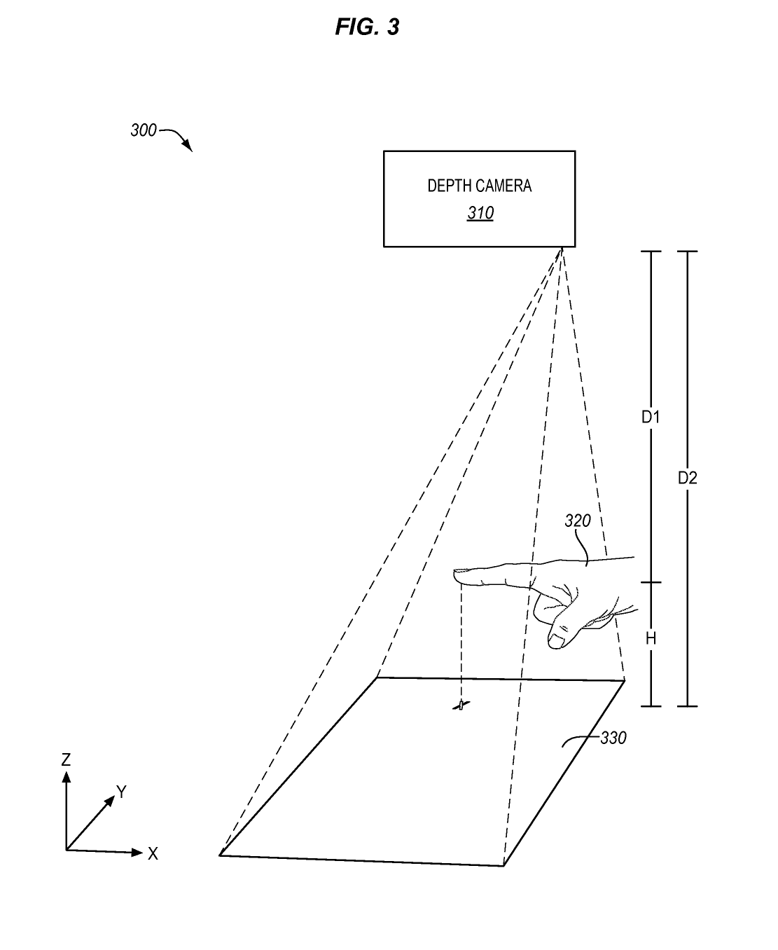

In step 204, controller 120 calculates the distance between depth camera 110 and objects represented by 3D pixels within the 3D images of the stream. The distance may be an aggregate value that represents one “distance” per 3D image. For example, for a 3D image, the calculated distance may equal the sum of the depth values of each 3D pixel in that image. FIG. 3 is a diagram 300 illustrating distance measurements (D1, D2) acquired by a depth camera 310 in an exemplary embodiment. As used herein, a “distance” or “depth” may be the direct, shortest line length from depth camera 110 to an object, or may be a single or multi-dimensional component of that line length (e.g., only the Z component of the shortest line length, only the XY component of the shortest line length), or any suitable combination of the various dimensions along which the line length may be measured. Thus, in one embodiment the points on plane 330 in front of depth camera 310 are considered to have different distances from depth camera 310 (because the distances are considered along X, Y, and Z dimensions), while in another embodiment all points on plane 330 are considered to have the same distance from depth camera 110 (because the distance from the camera to each point is only analyzed/considered along the Z dimension).

FIG. 3 also illustrates how height may be calculated from depth. In FIG. 3, the height of focal object 320 may be determined by identifying a depth D2 of a predefined amount/level (e.g., the depth of a reference surface), determining a depth D1 to the focal object, and subtracting D1 from D2 to arrive at H. Analyzing 3D pixels for a given 3D image may include converting X/Y/Z and/or depth information to height information as desired. Thus, any discussions referring to calculations made based on height may alternatively be made based on depth, and vice versa.

In a further embodiment, calculating the distance between camera 110 and the objects represented in a 3D image comprises identifying the 3D pixels in the image that are closer than a threshold amount to camera 110, and summing the depths of each of those 3D pixels. In yet another embodiment, calculating the distance to the objects includes summing the depth of each 3D pixel that is more than a certain height above a currently defined reference plane, or summing the depth of each 3D pixel of the closest set of 3D pixels to camera 110.

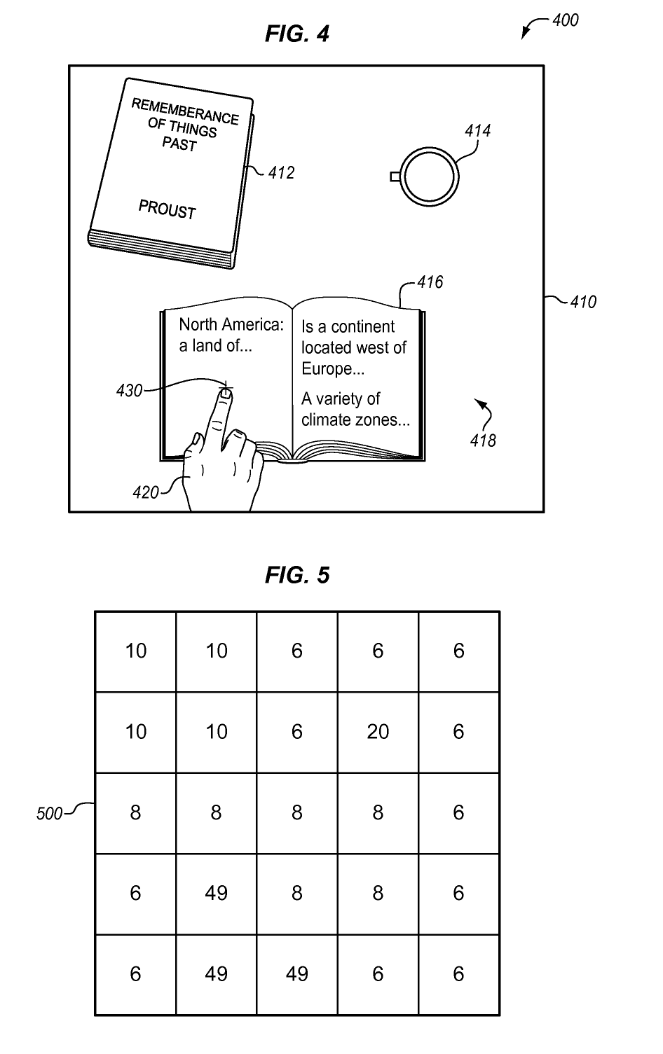

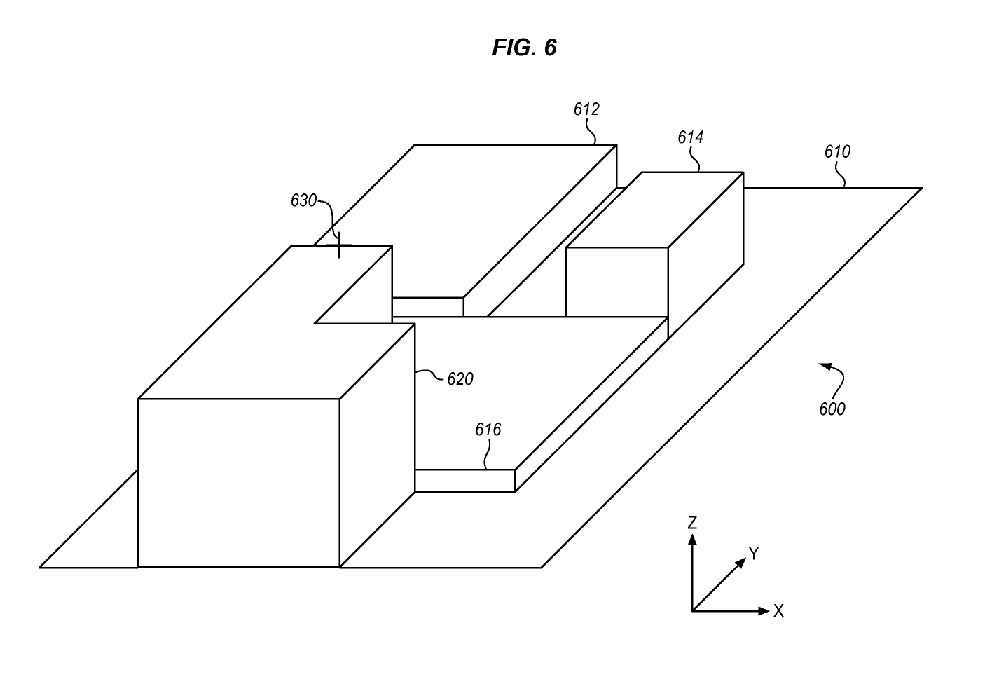

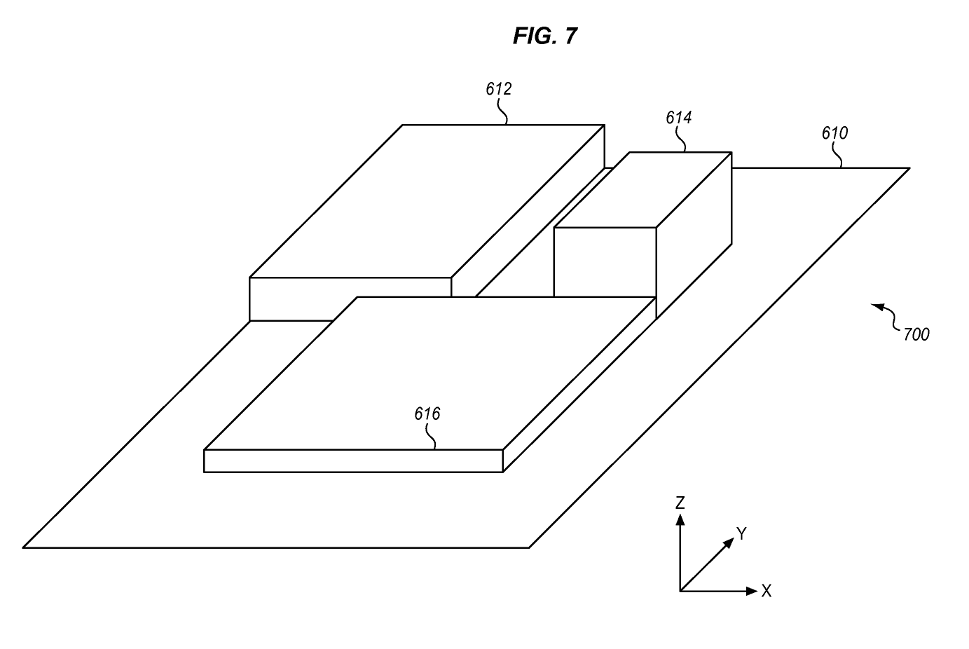

FIG. 4 is a diagram 400 illustrating a top view of a physical workspace and associated reference surface for which distances may be calculated in an exemplary embodiment. In this example, workspace 410 includes a closed book 412, a coffee mug 414, and an open book 416 resting on a table surface 418. Workspace 410 further includes a pointing hand 420 indicating a gesture location 430. FIG. 5 is a diagram 500 illustrating of a set of 3D pixels representing physical workspace 410 of FIG. 4 in an exemplary embodiment. The number of 3D pixels in FIG. 5 has been vastly reduced when compared with most 3D images for the sake of enhancing clarity, as a person of ordinary skill in the art will appreciate that a 3D image may include millions of 3D pixels. According to FIG. 5, each 3D pixel (represented by a voxel/box/cell) is associated with an X and Y coordinate, as well as a measured depth, based on the distance between the object it represents and depth camera 110. 3D pixels may also include a color value and/or brightness/luminance value. In FIG. 4, the 3D pixels representing the pointing hand 420 are the highest, while those representing the surface of the table 418 are the lowest. FIG. 6 is a diagram 600 illustrating a perspective view of the set of 3D pixels representing physical workspace 410 in an exemplary embodiment. In this perspective view, 3D pixels 610 represent workspace 410, 3D pixels 612 represent closed book 412, 3D pixels 614 represent coffee mug 414, 3D pixels 616 represent open book 416, and 3D pixels 630 represent hand 420. Gesture location 430 may be identified as a group of 3D pixels 630 at the location of the tip of the user's hand.

In step 206, controller 120 identifies an increase in distance between the objects and depth camera 110 over time, based on the 3D pixels in the 3D images of the stream. This detection may be performed by comparing the distance calculated for a current 3D image against the distance calculated for a prior 3D image (e.g., the immediately prior image). If the distance has increased by more than a threshold amount (e.g., corresponding to at least a two centimeter increase in average depth) over a defined period of time (e.g., one second, one frame, etc.), then the increase in distance may be sufficient to indicate that a user is quickly lowering their hand or removing their hand from the workspace 102 as an intentional command. This increase in distance may continue for a series of 3D images over time.

Determining that the distance to the objects in the workspace has increased is relevant because a focal object, such as a hand, is likely to be the closest object to depth camera 110. Therefore, if a user's hands are being withdrawn from the workspace, the 3D pixels representing the hands that previously were high as shown in FIG. 6 may drop in height to the level of the underlying surface.

In step 208, controller 120 detects a pause following the increase in distance. During the pause, the distance between depth camera 110 and the 3D pixels remains substantially constant. The pause may therefore indicate that a user is keeping her intended command hand out of the workspace. In one embodiment, the pause is detected whenever there is no substantial change in distance between camera 110 and the 3D pixels of incoming images (e.g., no change of more than a threshold amount) for a predefined period of time (e.g., one second, one frame, etc.).

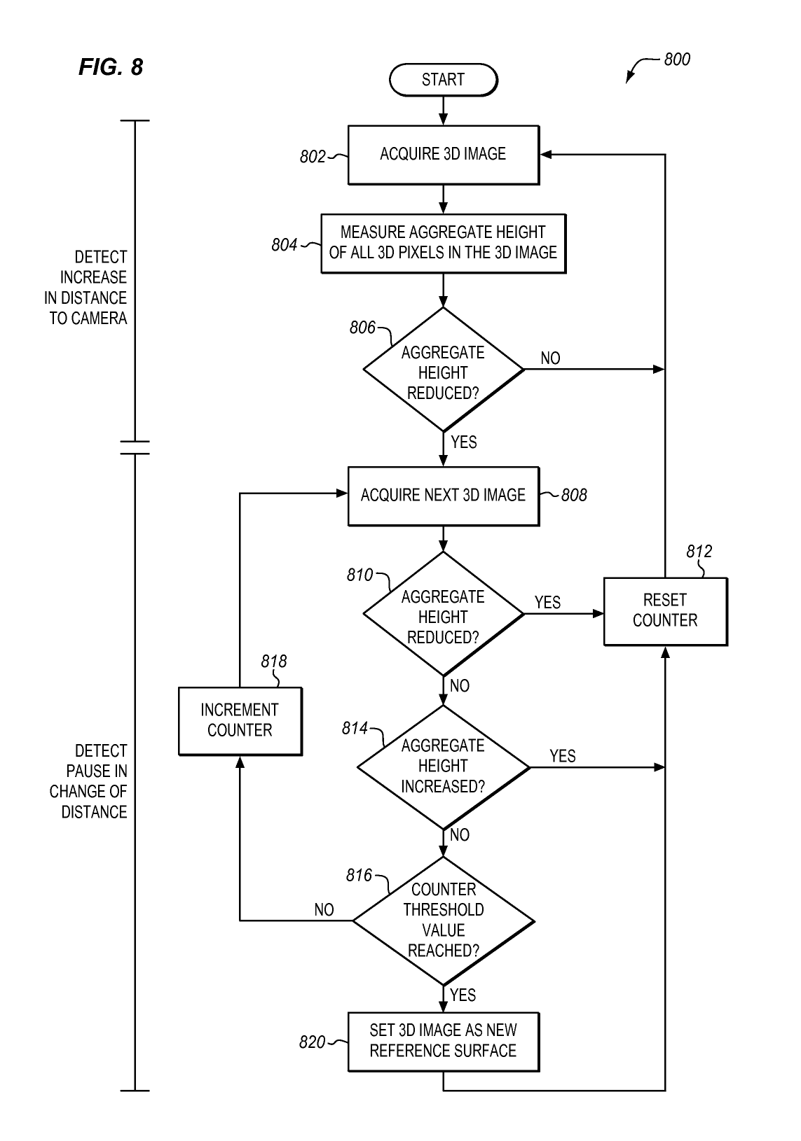

In step 210, controller 120 defines a reference surface corresponding to a 3D image of workspace 102 acquired during the pause. The new reference surface represents the shape of the physical workspace while it is not being actively interacted with. In one embodiment, the reference surface is a flat 2D surface defined a specific depth, such as the largest depth detected by camera 110 (corresponding to a lowest detected surface of the workspace). In another embodiment, the reference surface is a 3D surface defined by the 3D image acquired during the pause. FIG. 7 is a diagram illustrating a perspective view of a 3D reference surface 700 defined for workspace 410 of FIG. 4 in an exemplary embodiment. In this example, since hand 630 from FIG. 6 has been withdrawn, the aggregate height of the 3D pixels has decreased and steadied at the heights shown in FIG. 7. These 3D pixels acquired during the pause are used to define a new 3D reference surface that includes the table, both books, and the coffee mug of FIG. 4.

Using steps 204-210 as described above, a reference surface may be quickly and dynamically defined and redefined by a user of imaging system 100 pulling their hands out of workspace 102. Since the reference surface may be defined and re-defined multiple times while imaging system 100 is being operated, a user of imaging system 100 does not have to worry that, for example, adding a book or coffee mug to the physical workspace will interrupt or otherwise unduly impact interaction with imaging system 100. This is because newly added objects can be rapidly integrated into the reference surface as controller 120 continuously and repeatedly performs steps 202 and 204-210.

Steps 212-220 describe how a defined reference surface may be used to detect user input and manage a display 140. In step 212, controller 120 identifies a change in the distance between the objects of the workspace (as represented by the 3D pixels of each 3D image in the stream) and depth camera 110 for a current 3D image. This may indicate that a user is again moving her hands in the workspace. This operation may be performed in a similar manner to step 206 above, except that decreases in distance may also cause controller 120 to identify a change (because a user may raise their hand to indicate a gesture). Just like with step 206, the change in distance may be detected for the aggregate 3D image as a whole when compared to the prior image, or some fraction thereof.

In step 214, controller 120 identifies a segment of the current 3D image that is closer to depth camera 110 than the reference surface is. This may be performed, for example, by determining the height of each 3D pixel in the current image, determining the height of each 3D pixel with respect to the reference surface, and identifying 3D pixels of the current image that are higher than 3D pixels of the reference surface at the same X/Y positions. In one embodiment, the segment must include at least a threshold number of 3D pixels, and/or must include a contiguous set of 3D pixels before processor 124 confirms that the segment actually represents user input and is not a false positive created by signal noise.

After the segment that is raised above the reference surface has been identified, in step 216 controller 120 identifies a gesture location within the current 3D image based on the identified segment. The gesture location may be determined as the centroid (center of mass) of the segment, a center point of a volume that encompasses the segment, a left/right, front/back, or top/bottom edge of the segment, etc. The gesture location itself may comprise a 3D, 2D, or 1D coordinate. In one embodiment, the gesture location is the 3D coordinate of the 3D pixel of the segment that has the highest Y value in the 3D image, wherein X and Y represent in-plane dimensions and Z represents depth/distance.

Controller 120 may further analyze the segment as desired. For example, when focal object 130 is a human hand, controller 120 may analyze the 3D pixels representing the hand to detect an angle between a thumb and a forefinger. In another example, controller 120 may determine a 3D or 2D vector indicated by the user's gesture. For example, controller 120 may detect uniquely distinguishable groups of 3D pixels representing a head and a tail portion, and may generate a vector connecting the two groups of 3D pixels. By extending the vector outward from the head of the vector by an offset amount (and/or by rotating the angle at which the display portion is shown to the user based on the vector), the controller may position/orient a display portion of the image based on the direction in which the user is pointing. In one embodiment, a vector head is uniquely distinguished from a vector tail based on a unique brightness, color, distal position, etc. Controller 120 then deterministically extends the vector from the tail to the head, and outward beyond the head by an offset amount. In a further embodiment, the head and tail are substantially similar to each other, and the controller extends the vector from the region having the lowest Y position on the segment to the region having the highest Y position on the segment.

In step 218, controller 120 identifies a data set in database 150 corresponding to the gesture location. Database 150 may be organized into a series of entries, and controller 120 may maintain information in memory 126 indicating which entries of database 150 are correlated with which gesture locations. For example, memory 126 may define XYZ volumes or planar XY positions of workspace 102 that each correspond with a different entry/data set in database 150. For example, the database may define a high resolution 2D image of the physical workspace acquired by a high resolution 2D camera (as discussed below), and each data set may correspond with a portion of the 2D image.

In step 220, controller 120 adjusts an output of display 140 based on information in the data set. Adjusting the output of display 140 may include any suitable operation for presenting new information to a user, based on the selected data set. Steps 212-220 therefore facilitate the updating of display 140, based on the determined locations of a user's gestures in workspace 102.

When steps 204-210 are used in conjunction with steps 212-220, imaging system 100 is capable of dynamically defining reference surfaces, which may then be used to segment 3D images in order to identify the location of user input. A user may alter her physical workspace 102 rapidly and efficiently, without needing to concern herself about whether imaging system 100 is improperly calibrated with respect to a reference surface, because the reference surface may be continually updated and redefined. For example, in one embodiment the reference surface may be recalibrated by the user moving their hands across the workspace, removing their hands, and waiting briefly for a new 3D image of the reference surface to be acquired.

Even though the steps of method 200 are described with reference to imaging system 100 of FIG. 1, method 200 can be performed in other imaging systems. The steps of the flowcharts described herein are not all inclusive and can include other steps not shown. The steps described herein can also be performed in an alternative order.

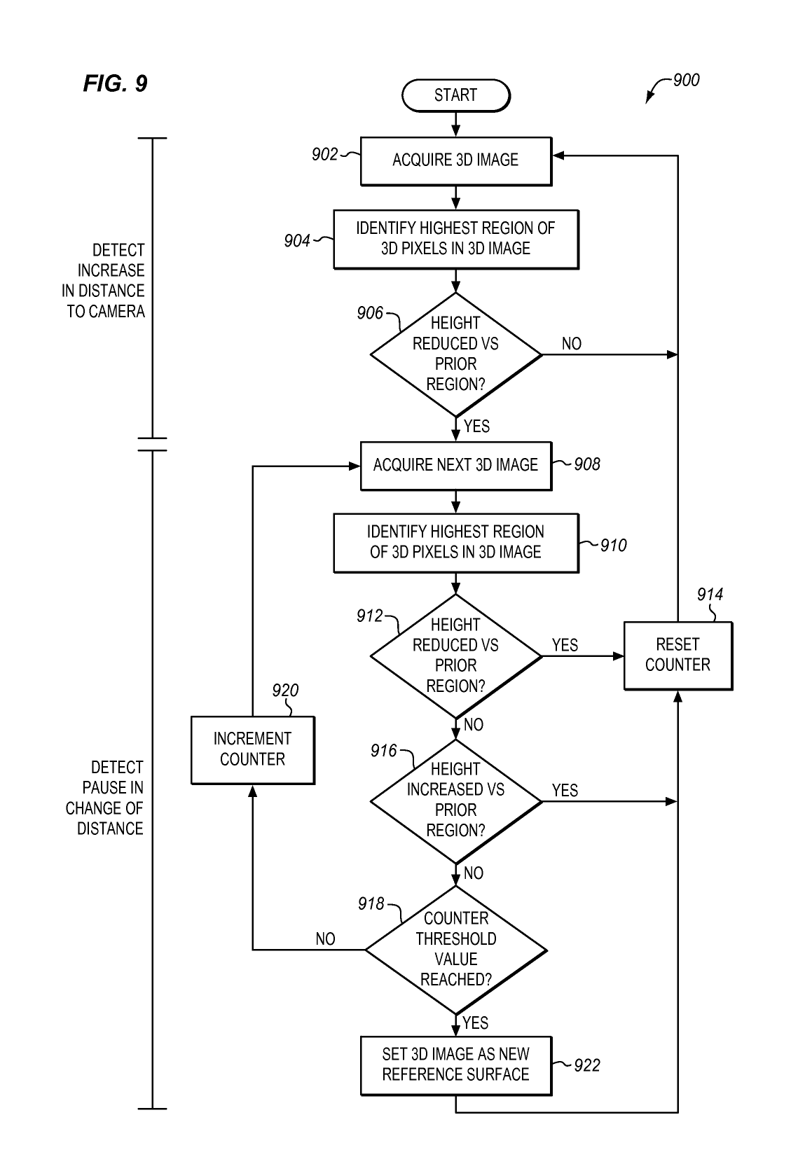

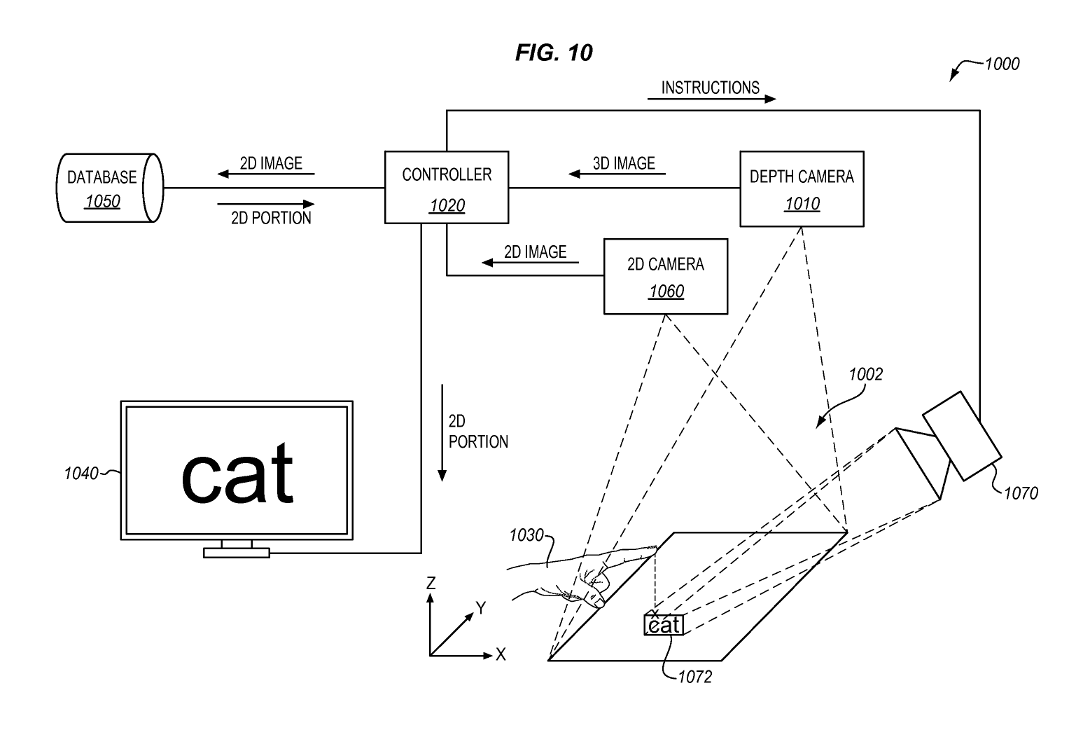

FIGS. 8-9 are flowcharts illustrating methods for defining a reference surface (such as reference surface 700 of FIG. 7) in an exemplary embodiment. Specifically, FIG. 8 illustrates an embodiment where the aggregate height of all 3D pixels in an image is used to detect changes in distance between workspace objects and a depth camera, while FIG. 9 illustrates an embodiment where the height of a region of the highest 3D pixels in an image is used to detect such changes. Each technique may be suitable in a variety of embodiments, depending on user and/or designer preference.

In FIG. 8, steps 802-806 illustrate the process of identifying an increase in distance between the workspace objects of each image and the depth camera. In step 802 a controller of the imaging system acquires a 3D image from a depth camera, and in step 804, the controller measures an aggregate height of all 3D pixels in the 3D image, by summing the height of each of the 3D pixels. In step 806, if the aggregate height of all of the 3D pixels in the 3D image has decreased with regard to a previously acquired 3D image, then processing continues to step 808. Otherwise processing returns to step 802.

Steps 808-820 illustrate steps performed to detect and respond to a pause. In step 808, the controller acquires another 3D image from the depth camera. If the 3D pixels of the current, newly acquired 3D image from step 808 have an aggregate decreased height in step 810 when compared to the immediately prior 3D image, or if the 3D pixels have an aggregate increased height in step 814 when compared to the immediately prior 3D image, then the distance between the depth camera and the workspace is still changing, and there is no pause. Thus, a counter is reset in step 812 and processing continues to step 802.

Alternatively, if the 3D image from step 808 has not increased or decreased in aggregate height (e.g., by at least a threshold amount) with respect to its predecessor, then a pause exists and processing continues to step 816, where a controller of the imaging system checks to determine whether the counter has reached a threshold value (e.g., 30 frames) indicating that the pause has continued for a sufficient period of time. If the counter has not reached the threshold value, then the counter is incremented in step 818 and processing continues to step 808. Alternatively, if the counter has reached the threshold value indicating that the pause has continued long enough, then the current 3D image is set as the reference surface in step 820, the counter is reset in step 812, and processing continues from step 802.

FIG. 9 illustrates an embodiment where the height of a region of 3D pixels in an image is used to detect a distance between a depth camera and a workspace with objects represented by a stream of 3D images. In FIG. 9, steps 902-906 illustrate the process of identifying an increase in distance. According to method 900, in step 902 a controller of the imaging system acquires a 3D image, and in step 904, the controller identifies a height of the highest region of 3D pixels in the 3D image (e.g., in the Z direction as shown in FIG. 7). This highest region of 3D pixels may be a contiguous region of 3D pixels (e.g., contiguous in the XY plane as shown in FIG. 7) that are within a threshold height of the highest 3D pixel, may be a contiguous region of a fixed number 3D pixels that has a higher average height than any other region of similar size, may be a set of 3D pixels within a certain radius (e.g., 3D radius or 2D XY planar radius) of the highest detected 3D pixel, may be a set of 3D pixels that are no more than a threshold distance away from the depth camera, or may be determined via any other suitable technique. In one embodiment, the highest region of 3D pixels is identified as a set of at least twenty contiguous 3D pixels that have a height higher than any other region of twenty contiguous 3D pixels.

An aggregate height of the region of 3D pixels is determined by summing the detected heights of its pixels. In step 906, if the aggregate height has reduced with regard to a region of 3D pixels in the prior 3D image, then processing continues to step 908. Otherwise processing returns to step 902. The change in aggregate height may either be determined by comparing the current region of 3D pixels in the current 3D image to the same region of 3D pixels in the previous 3D image, or comparing the current region of 3D pixels to a previous highest region of 3D pixels for the previous image.

Steps 908-922 illustrate steps performed to detect and respond to a pause. In step 908, the controller acquires another 3D image from the depth camera, and in step 910 the controller identifies the highest region of 3D pixels in the 3D image. If the highest region of the current, newly acquired 3D image from step 910 has a decreased height in step 912 when compared to a prior 3D image (e.g., the immediately prior 3D image), or if the region has an increased height in step 916 when compared to the immediately prior 3D image, then the distance between the depth camera and the workspace is still changing, and there is no pause. Thus, a counter is reset in step 914 and processing continues to step 902.

Alternatively, if the region identified in step 910 has not increased or decreased in aggregate height (e.g., by at least a threshold amount) with respect to its predecessor, then a pause exists and processing continues to step 918, where a controller of the imaging system checks to determine whether the counter has reached a threshold value (e.g., 2 seconds) indicating that the pause has continued for a sufficient period of time. If the counter has not reached the threshold value, then the counter is incremented in step 920 and processing continues to step 908. Alternatively, if the counter has reached the threshold value indicating that the pause in change in height has continued long enough, then the current 3D image is set as the reference surface in step 922, the counter is reset in step 914, and processing continues from step 902.

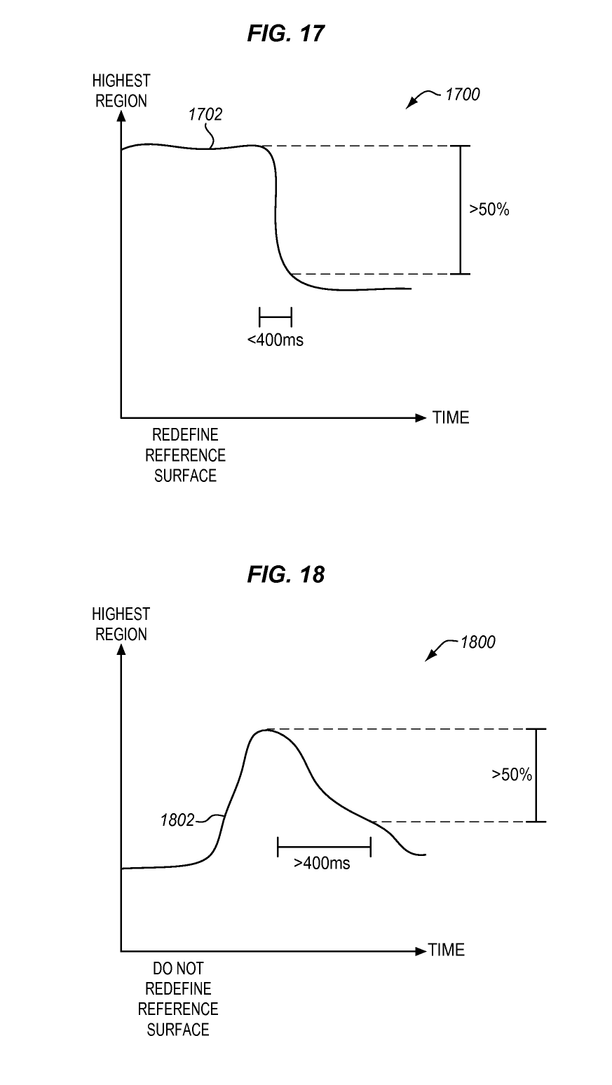

The controller may use any suitable further processing techniques to define triggers for redefining the reference surface. For example, the controller may define a trigger based on the rate at which the heights are detected as changing, and/or the magnitude of those changes. FIGS. 15-18 are diagrams illustrating trigger conditions for redefining a reference surface in an exemplary embodiment. Specifically, FIGS. 15-16 illustrate a trigger condition where the change in aggregate height of a region of 3D pixels is considered (e.g., all 3D pixels in a 3D image, or a subset thereof), while FIGS. 17-18 illustrate a trigger condition where the change in height of a highest group of 3D pixels is considered. In FIGS. 15-16, if a greater than ten percent decrease/change in aggregate height is detected over a period of time corresponding to less than 400 milliseconds (ms) from the current frame/3D image, then a controller waits for a one second pause (e.g., a lookback period during which the aggregate height does not substantially change) and redefines the reference surface based on the latest 3D image, because the detected changes are indicative of a hand being removed from the workspace. This situation is illustrated by plot 1502 on diagram 1500. In contrast, if a greater than ten percent change in aggregate height is detected over a longer period of time than 400 ms from the current frame/3D image, then no trigger is detected (because the motion is more similar to a hand being slowly lowered to point to something in the workspace, such as a book). This situation is illustrated by plot 1504 on diagram 1600.

In FIGS. 17-18, if a greater than fifty percent decrease/change in height is detected for the highest 3D pixel, over a period of time corresponding to less than 400 ms, then a controller waits for a one second pause (e.g., a lookback period during which the height does not substantially change), and redefines the reference surface based on the latest 3D image. This situation is illustrated by plot 1702 on diagram 1700. In contrast, if a greater than fifty percent change in aggregate height is detected over a longer period of time than 400 ms, then no trigger is detected. This situation is illustrated by plot 1802 on diagram 1800.

In a further embodiment, a triggering condition causing the reference surface to be redefined (e.g., to match a current 3D image in the stream) is caused whenever a user moves a retro reflective object (as represented by one or more 3D pixels that the controller identifies as being above a threshold level of brightness/luminance) down rapidly (thereby reducing the 3D pixel(s)' height by at least a threshold amount over a threshold period of time). A controller then waits to identify a pause wherein the user zig zags the retroreflective pointer across the surface (e.g., as indicated by rapid perturbations of the bright 3D pixel(s) in the X and/or Y directions), and then identifies a cutoff where the user moves the retro reflective object (as indicated by the bright 3D pixel(s)) rapidly upward by at least a threshold rate and magnitude in a jerking motion towards the depth camera to set the reference surface. In this embodiment, the reference surface may be redefined as the depth(s) of the zig zag motions, corresponding with a surface shown in a 3D image of the physical workspace during the pause. The reference surface may also be redefined as a 3D image taken after the retro reflective object has been removed from view.

### EXAMPLES

In the following examples, additional processes, systems, and methods are described in the context of a variety of imaging systems.

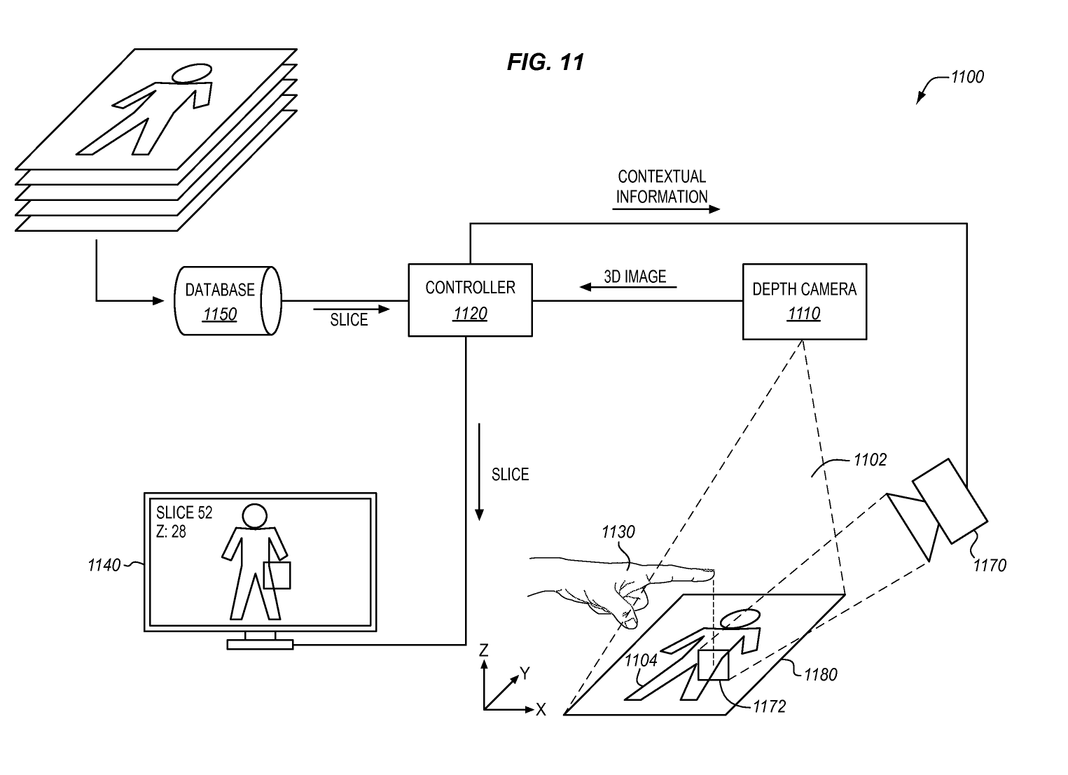

FIG. 10 is a diagram illustrating an imaging system 1000 for assisting reading an exemplary embodiment. Imaging system 1000 may be used to facilitate reading by the visually impaired, or to teach reading to those who desire to learn. Imaging system 1000 includes controller 1020, which operates depth camera 1010 and 2D camera 1060 in order to identify user input, and provides enhanced, high-resolution views of workspace 1002 from database 1050 to display 1040. In this example, controller 1020 also manages an optional projector 1070 to visually highlight regions of workspace 1002. Controller 1020 (and any of the controllers described in these examples) may be implemented as custom circuitry, a general-purpose processor executing programmed instructions, etc.

In this example, a user moves a focal object 1030, such as a finger, across workspace 1002. Controller 1020 continuously acquires 3D images from depth camera 1010, and 2D high-resolution images from 2D camera 1060. The 2D images have a much higher planar (2D) resolution than the 3D images. Specifically, in this example, the 2D images are twenty Megapixel images acquired in a similar or smaller field of view than the field of view used for the 3D images. The 2D images are stored by controller 120 in database 150 (stored on a memory device). By segmenting via the techniques described above, controller 1020 is able to detect a 3D coordinate (X,Y,Z) indicating the location of a pointing gesture at the tip of focal object 1030. Specifically, in this embodiment controller 1020 defines a 3D reference surface representing a static version of workspace 1020 whenever a user removes focal object 1030 from the field of view of depth camera 1010 for a period of one second. The current high resolution 2D image in database 1050 is replaced with a newly uploaded high resolution 2D image whenever the reference surface is redefined.

When continuous motion is again detected in the field of view of depth camera 1010 (e.g., when controller 1020 detects that a newly acquired 3D image exhibits 3D pixels of different heights than its immediate predecessor), controller 1020 discards 3D pixels found in the same height/depth as the reference surface, and determines that the remaining 3D pixels make up focal object 1030. Controller 1020 then determines a representative 3D coordinate of focal object 1030. In this embodiment, the representative 3D coordinate is determined by selecting the 3D pixel of focal object 1030 that has the highest Y value.

Controller 1020 extracts X and Y values from the 3D coordinate to determine the center of a portion of a high resolution 2D image for magnification on display 1040 (this is also referred to as a “locus”). In this example, controller 1020 includes data in memory that correlates volumes of workspace 1002 and/or the reference surface with portions of the high resolution 2D image. This enables controller 1020 to link pointing input from a user in workspace 1002 to portions of the most recent high-resolution 2D image as stored in database 1050.

Controller 1020 further extracts the Z value from the 3D coordinate to determine a level of magnification to provide at display 1040. This level of magnification may be set to specific levels that are each correlated with a range of Z values, or may be continuous (and capped at a number below infinity) depending on the height of focal object 1030 over the defined reference surface. In a further embodiment, only a part of display 1040 is used to present the magnified portion of the image. This may be desirable when display 1040 includes a Graphical User Interface (GUI) for interacting with the imaging system. In such circumstances, the level of scaling may be selected by the controller to fit the available part of display 1040. Once the center and level of scaling are determined, controller 1020 identifies a data set from database 1050 defining a portion of the 2D image representing the gesture location, and directs display 1040 to present a magnified version of the portion.

In this example, controller 1020 may also perform Optical Character Recognition (OCR) on the magnified portion shown on display 1040, and operates a speaker at display 1040 to recite words in the magnified portion (e.g., all words in the region, or the closest word to the gesture location of the user). Controller 1020 also operates projector 1070 with instructions to highlight the magnified region with a distinguishing color and/or brightness. Controller 1020 may further direct projector 1070 to highlight the entire region being magnified, text found within the region being magnified, and/or individual words within the region (e.g., as those words are being spoken via controller 1020, or as those words are being pointed to by a user), as shown in 1072.

Controller 1020 may further maintain correlation information in memory that correlates 3D volumes of space (or 3D positions) with individual pixels at projector 1070. In this manner, different objects located at the same X and Y coordinate for 2D camera 1060, but having vastly different Z coordinates from each other, would cause controller 1020 to direct projector 1070 to project light to different physical volumes of the workspace. This ensures that instructions sent to projector 1070 account for the depth as well as the planar location of objects in workspace 1002. Such techniques for dynamically highlighting areas of workspace 1002 allow for enhanced user experiences related to augmented reality. As used herein, augmented reality refers to machine-based interpretation and enhancement of real-world content with contextual or other information presented to the user.

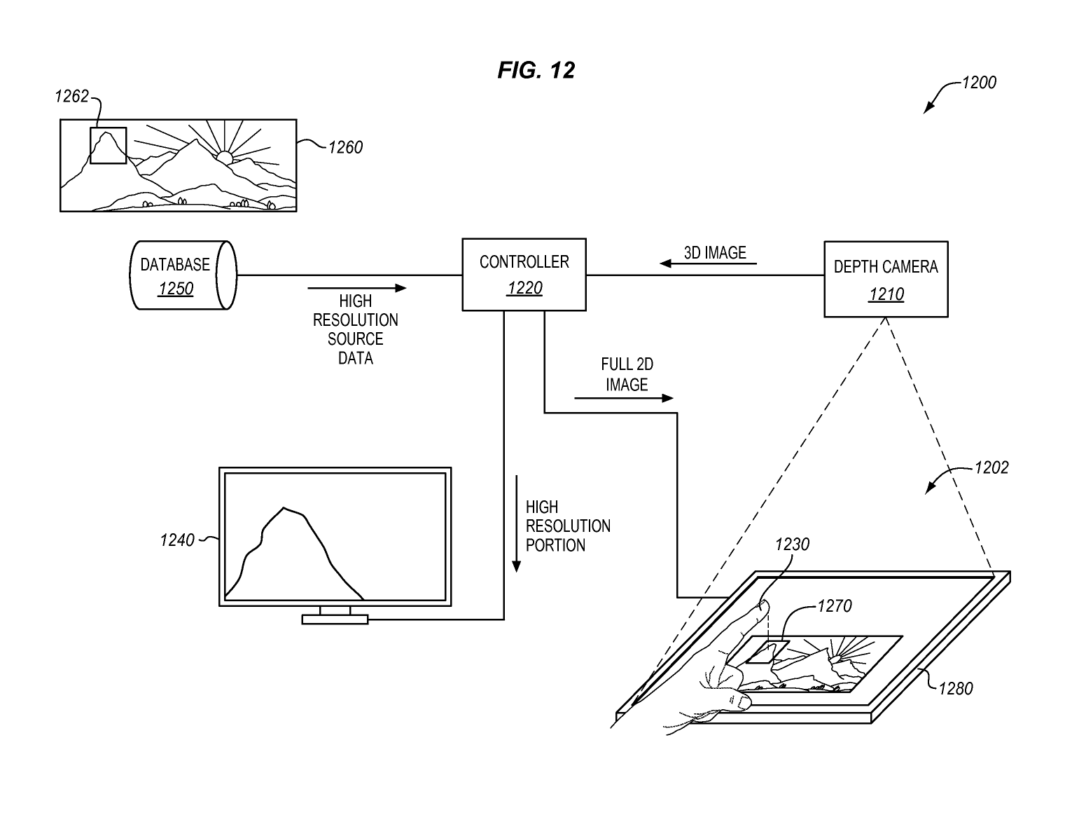

FIG. 11 is a diagram illustrating an imaging system 1100 for viewing medical scans in an exemplary embodiment. Specifically, in this example a medical workspace 1102, such as a table 1180 of an operating room, includes a patient (Catherine) or image of the patient, as shown in 1104. A user moves a focal object (e.g., a finger or sterile wand) over workspace 1102, and imaging system 1100 dynamically provides contextual information via projector 1170 and display 1140. Imaging system 1100 includes controller 1120 and depth camera 1110. Controller 1120 identifies user input from a focal object 1130 within workspace 1102 based on input from depth camera 1110, and proceeds to acquire slices of medical imaging of a human body (e.g., X-ray computed tomography (CAT scans), Magnetic Resonance Imaging (MRI) scans, etc.) or even an other object such as a manufactured product, an underground structure, etc. from database 1150.

Specifically, controller 1120 identifies the 3D coordinate of a gesture location indicated by focal object 1130. Controller 1130 delineates workspace 1102 along the Z axis into individual regions that each correspond with a small range of Z coordinates. Each region corresponds with a different planar slice of image data acquired via medical imaging. Thus, by extracting the Z value from the 3D coordinate, a slice can be selected. Controller 1120 also utilizes the X and Y values of the 3D coordinate to identify a position of interest for a given slice. Thus, using the 3D coordinate representing the tip of focal object 1130, controller 1120 identifies a slice of image data to present, as well as an in-plane portion of the slice to show on display 1140. Controller 1120 retrieves this information as a data set from database 1150, and directs the information to display 1140 for presentation. Controller 1120 is further operable to direct projector 1170 to highlight (e.g., via color or brightness) the region of the patient being viewed (e.g., region 1172), and/or to project slice image data or other surgical information directly onto the patient. This allows a surgeon to rapidly and intuitively understand the arrangement of an individual patient's internal organs. Other information projected onto the patient may include the location of an object to be operated upon (e.g., an internal organ for removal, such as a kidney, burst appendix, tumor, etc.) as indicated by a circle, highlighting, or an image of the object, or instructions for performing diagnostic or surgical procedures. This information may also be projected onto the detected focal object (e.g., the back of a user's hand) as desired. A user may further utilize a “clicker” or other electronic input device to provide input to controller 1120 to freeze the output shown on display 1140.

In a further embodiment, the controller directs display 1140 to present a blended view, wherein a “cut-away” of a patient is shown. Specifically, in the cut-away view a live feed of the patient on an examining table is combined and aligned on display 1140 with a portion of a slice of that patient, causing display 1140 to allow a doctor to “peek into” the patient via display 1140. In a further embodiment relating to Computer-Aided Design (CAD) systems, each slice may show a view of a cut-through solid/object taken from a viewpoint at a specific depth, wherein the location/plane of the cut dynamically changes as the user's gesture location/depth changes.

In this example, controller 1120 also exhibits a dynamic gesture control system, wherein the angle at which a slice is presented on display 1140 depends on the XY planar component of a vector defined between the base of focal object 1130 (e.g., the base of a finger, a wrist, an elbow) and the tip of focal object 1130. When focal object 1130 is a human hand, controller 1120 calculates an angle between the thumb and forefinger in order to identify an amount of zoom to provide for the selected region on display 1140.

The angle between the thumb and index finger is related to the distance between the index finger tip and the thumb tip. This is sufficiently constant between users to be used for magnification. When a user reaches into the workspace in the positive Y direction with the right hand and has a closed hand except for the thumb and index finger, then the segmented hand outline can be analyzed as follows to find the thumb-index distance. First, a controller may identify a location of the index finger tip point as the point with the largest Y value on the segmented hand. Next, the controller may identify a location of the thumb tip as the point with the lowest X value on the segmented hand. The thumb-index distance may be defined as the distance between these points. An angle may then be calculated based on the distance between the location of the index finger tip and thumb tip. A controller may further set magnification limits (e.g., a maximum magnification at a thumb-index distance of greater than or equal to five inches, a minimum magnification at a thumb-index distance of less than or equal to two inches). If a user uses the left hand then the point with the lowest X value on the segmented hand discussed above may instead be selected as the point with the highest X value on the segmented hand.

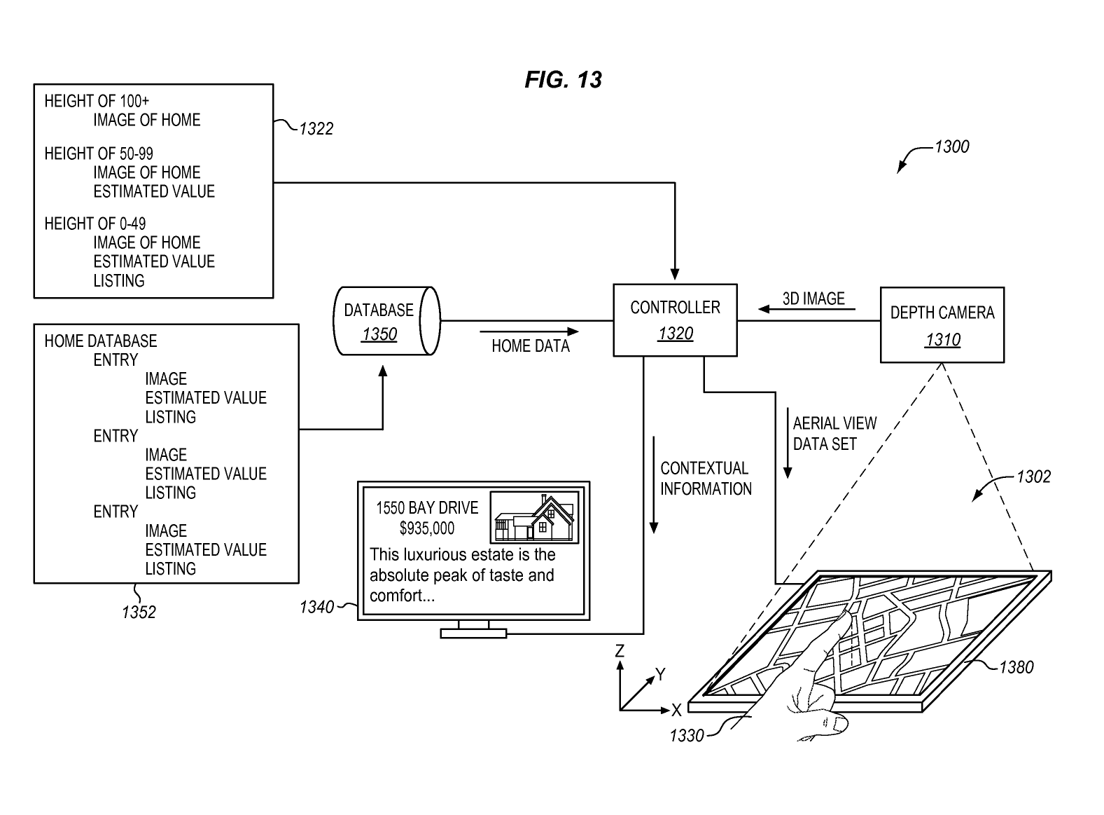

FIG. 12 is a diagram illustrating an imaging system 1200 for presenting network accessible contextual information in an exemplary embodiment. In this example, a digital display 1280 is integrated into workspace 1202. Display 1280 provides an image of a document, a piece of artwork, etc. For example, display 1280 may be a horizontal table-mounted display or a vertical wall-mounted display used to present a map of a subway systems. Controller 1220 may provide image data for presentation on display 1280.

Imaging system 1200, comprising controller 1220 and depth camera 1210, detects a location of a gesture indicated by a focal object 1230 to identify a region 1270 for high-resolution viewing, and presents the high-resolution region on display 1240.

Specifically, in this example display 1280 illustrates a famous painting 1260. Controller 1220 acquires a 3D coordinate indicating a tip of focal object 1230 by identifying the 3D pixel, higher than the reference surface defined by display 1280, that has the highest Y value. Controller 1220 then identifies a region 1270 of the image on display 1280 to magnify, based on the X and Y components of the 3D coordinate. This corresponds to region 1262 depicting painting 1260, as stored in a remotely hosted database 1250 (e.g., a database accessible via an Internet server, and hosted by an art auction service).

Controller 1220 further determines a level of magnification/detail for the image based on the Z value of the 3D coordinate. Controller 1220 then identifies a resolution of display 1240. Based on this information, controller 1220 requests a data set from a server hosting database 1150, wherein the data set comprises a high-resolution version of region 1262 (corresponding to region 1270) from database 1250. Upon receiving the high-resolution data, controller 1220 instructs display 1240 to present the region in high resolution. This enables many users to closely inspect painting 1260 without crowding each other out or potentially damaging painting 1260.

In a further version of FIG. 12, display 1280 fulfills the role of display 1240, and display 1240 is not included. Thus, instead of display 1280 showing a static version of painting 1260, display 1280 presents dynamically changing content, wherein different high resolution portions of painting 1260 are shown on display 1280.

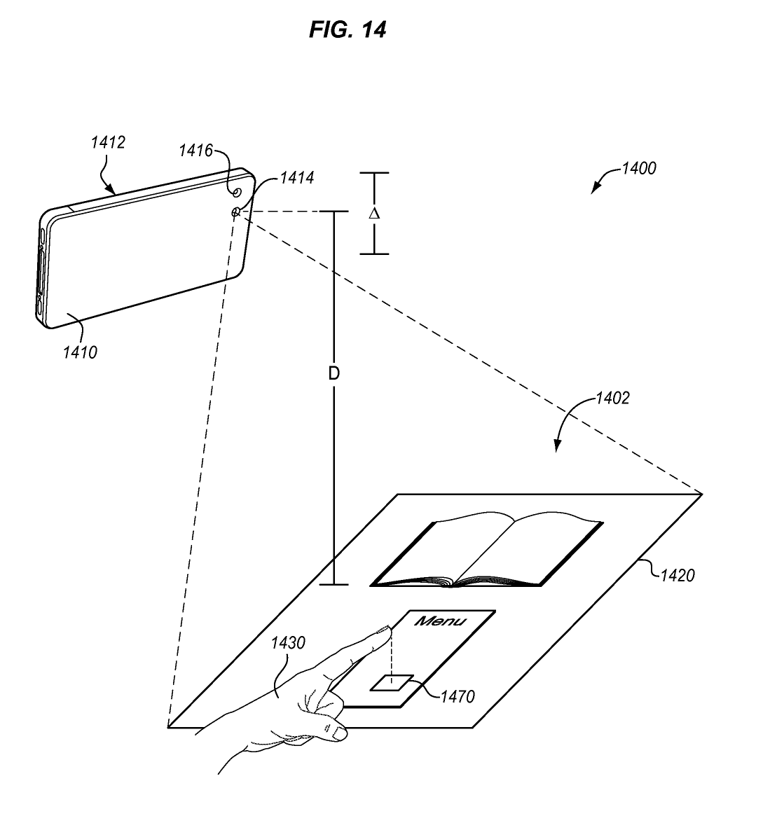

FIG. 13 is a diagram 1300 illustrating a further imaging system for presenting network accessible contextual information in an exemplary embodiment. According to FIG. 13, imaging system 1300 includes a controller 1320 and a depth camera 1310. Depth camera 1310 images a workspace 1302 with a reference surface that comprises a flat display 1380, which presents (via controller 1320) an aerial map of a subdivision of houses described in a home database 1350. A user indicates the location which they would like to view, as well as a desired level of detail, by moving a focal object 1330 across workspace 1302. Controller 1320 identifies the location of focal object 1330 as a 3D coordinate of the tip of focal object 1330, and extracts an XY planar coordinate from the 3D coordinate indicating a home that focal object 1330 is presently hovering over. A Z coordinate is also extracted from the 3D coordinate. Based on the height of the Z coordinate, one of several tiers of information is provided. Specifically, as shown in FIG. 13, rules 1322 stored in a memory of controller 1320 indicate that different information should be provided for each of three different levels of height for focal object 1330. When controller 1320 identifies the 3D coordinate representing a gesture by focal object 1330, it accesses a home database table 1352 correlated with the XY planar coordinate, and selects a level of detail based on the Z value of the current 3D coordinate. Controller 1320 then retrieves a data set from database table 1352 comprising the entry or a portion thereof. Then, controller 1320 directs display 1340 to present the entry, based on the determined level of detail. In this example, there are three levels of detail, one of which is an image of the home (e.g., aerial photo or listing photo), another of which is an image of the home along with an estimated value, and yet another of which includes an actual listing for the home.

In a further version of FIG. 13, display 1380 fulfills the role of display 1340, and display 1340 is not included. Thus, instead of display 1380 showing an aerial view of a neighborhood, display 1380 presents dynamically changing content, wherein different home listings are displayed at different levels of detail.

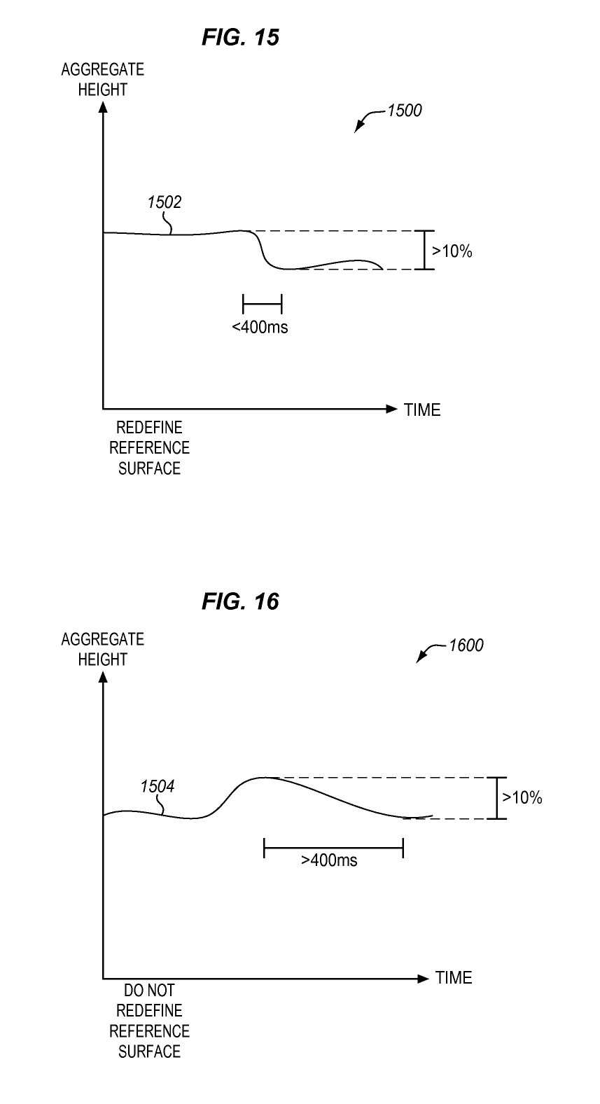

FIG. 14 is a diagram 1400 illustrating an imaging system implemented on a mobile device 1410 in an exemplary embodiment. In this example, mobile device 1410 is a tablet computer that includes a screen 1412 which presents a view of a workspace 1402, a 2D camera 1416, and a depth camera 1414 to image a workspace 1402 including a reference surface 1420. The reference surface 1420 is a depth D from camera 1414, and a user's hand 1430 is above the reference surface 1420 in order to draw attention to a region 1470 on workspace 1420. The fundamentals of human biomechanics ensure that camera 1414 will move slightly back and forth when being operated, even when a user intends to hold camera 1414 steady. In order to ensure that reference surface 1420 is not redefined accidentally by a user, a safety zone is defined wherein perturbations in camera position within a range Δ will not trigger redefining reference surface 1420. That is, at least a threshold amount of motion must be detected by mobile device 1410 before mobile device 1410 uses a new 3D image to define reference surface 1420. The motion may be detected based on input from an accelerometer, or changes in 3D images over time that indicate mobile device 1410 is moving (e.g., because all 3D pixels in the 3D image have changed height by the same or a similar amount).

Mobile device 1410 may further dynamically recalculate the calculated heights/depths of individual 3D pixels in reference surface 1420, based on detected motion of mobile device 1410. Thus, if mobile device 1410 moves away from reference surface 1420, mobile device 1410 may shift the 3D pixels of reference surface 1420 correspondingly. The motion of mobile device 1410 may be detected, for example, by detecting that the height of more than a threshold amount of 3D pixels in a 3D image (e.g., 60% of the 3D pixels) have changed in height since the previous 3D image.

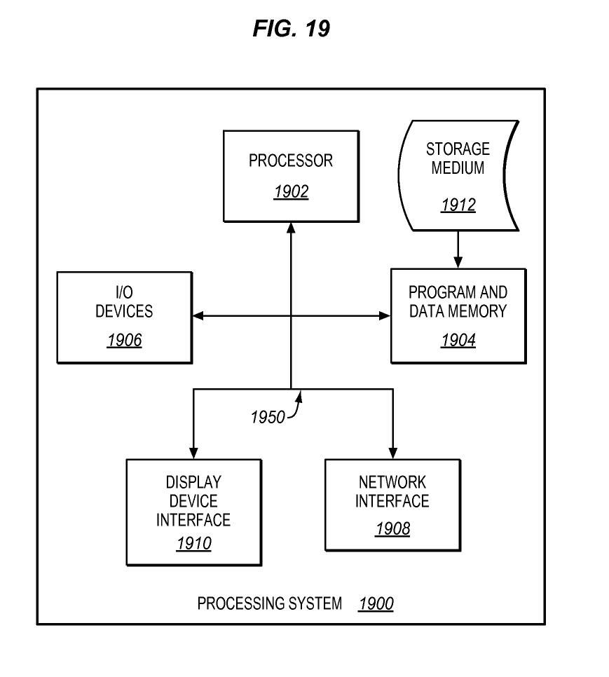

Embodiments disclosed herein can take the form of software, hardware, firmware, or various combinations thereof. In one particular embodiment, software is used to direct a processing system of imaging system 100 to perform the various operations disclosed herein. FIG. 19 illustrates a processing system 1900 operable to execute a computer readable medium embodying programmed instructions to perform desired functions in an exemplary embodiment. For example, such instructions may be written to control the operation of a tablet computer or laptop computer. Processing system 1900 is operable to perform the above operations by executing programmed instructions tangibly embodied on computer readable storage medium 1912. In this regard, embodiments of the invention can take the form of a computer program accessible via computer-readable medium 1912 providing program code for use by a computer or any other instruction execution system. For the purposes of this description, computer readable storage medium 1912 can be anything that can contain or store the program for use by the computer.

Computer readable storage medium 1912 can be an electronic, magnetic, optical, electromagnetic, infrared, or semiconductor device. Examples of computer readable storage medium 1912 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1900, being suitable for storing and/or executing the program code, includes at least one processor 1902 coupled to program and data memory 1904 through a system bus 1950. Program and data memory 1904 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1906 (including but not limited to keyboards, displays, pointing devices, etc.) can be coupled either directly or through intervening I/O controllers. Network adapter interfaces 1908 may also be integrated with the system to enable processing system 1900 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 1910 may be integrated with the system to interface to one or more display devices, such as printing systems and screens for presentation of data generated by processor 1902.

Although specific embodiments were described herein, the scope of the invention is not limited to those specific embodiments. The scope of the invention is defined by the following claims and any equivalents thereof.

I claim:

1. A system comprising:
a depth camera operable to generate three dimensional (3D) images of a physical workspace; and
a controller operable to acquire a stream of 3D images from the camera, to calculate distances between the depth camera and objects within the physical workspace that are represented by 3D pixels within the 3D images of the stream, to identify an increase in distance between the objects and the depth camera over time based on the 3D pixels, to detect a pause following the increase in distance, and to define a reference surface corresponding to a 3D image of the physical workspace during the pause,
wherein the controller is further operable to identify a change in distance between the objects and the depth camera for a current 3D image acquired after defining the reference surface, to identify a segment of the current 3D image that is closer to the depth camera than the reference surface, and to determine a gesture location within the current 3D image based on the identified segment,
wherein the controller is further operable to identify a data set corresponding to the gesture location, and adjust an output of a display based on information in the data set.

2. The system of claim 1, wherein:
the controller is operable to calculate distances between the depth camera and the objects by determining a depth of each of multiple 3D pixels in a 3D image, and summing the determined depths.

3. The system of claim 1, wherein:
the controller is operable to continuously and repeatedly, while acquiring the stream of 3D images, identify an increase in distance, detect a pause, and define a reference surface.

4. The system of claim 1, wherein:
the system further comprises a two dimensional (2D) camera, and the controller is operable to store 2D images from the 2D camera in memory, to identify the data set as a portion of a 2D image proximate to the gesture location in the physical workspace, and to direct the display to present a magnified version of the portion of the 2D image.

5. The system of claim 1, wherein:
the controller is operable to access a memory storing a multi-slice scan of an object, wherein each slice is a two dimensional (2D) image, and
the controller is operable to identify a 3D coordinate of the gesture location within the physical workspace, to identify a slice for viewing based on one dimension of the 3D coordinate, to identify the data set as an in-plane portion of the identified slice for viewing based on two dimensions of the 3D coordinate, and to direct a display to present the portion of the identified slice.

6. The system of claim 1, wherein:
the physical workspace comprises another display presenting a target image, and
the controller is operable to identify a 3D coordinate of the gesture location within the physical workspace, to identify a portion of the target image for viewing based on two dimensions of the 3D coordinate, to identify a level of magnification based on one dimension of the 3D coordinate, to contact a server to retrieve the data set, wherein the data set comprises a high-resolution version of the portion of the target image, and to direct the display to present the high-resolution version of the portion.

7. The system of claim 1, wherein:
the physical workspace comprises another display presenting a target image,
the controller is operable to identify a 3D coordinate of the gesture location within the physical workspace, to identify a portion of the target image based on two dimensions of the 3D coordinate, to identify the data set as an entry in a database based on the portion of the target image, to identify a level of detail based on one dimension of the 3D coordinate, and to direct the display to present the entry in the database based on the identified level of detail.

8. The system of claim 1, further comprising:
a projector operable to project visible light onto the physical workspace, wherein
the controller is operable to identify a 3D coordinate of the gesture location within the physical workspace, to identify a portion of the physical workspace based on two dimensions of the 3D coordinate, to perform Optical Character Recognition (OCR) on the portion of the physical workspace to identify a written word within the physical workspace, to direct the projector to highlight the written word,
wherein the data set is an image of the portion, and the controller is operable to direct the display to present a magnified version of the portion.

9. A non-transitory computer readable medium embodying programmed instructions which, when executed by a processor, are operable for performing a method comprising:
acquiring a stream of three dimensional (3D) images of a physical workspace from a depth camera;
calculating distances between the depth camera and objects represented by 3D pixels within the 3D images of the stream;
identifying an increase in distance between the objects and the depth camera over time based on the 3D pixels;
detecting a pause following the increase in distance;
defining a reference surface corresponding to a 3D image of the physical workspace during the pause,
identifying a change in distance between the objects and the depth camera for a current 3D image acquired after defining the reference surface;
identifying a segment of the current 3D image that is closer to the depth camera than the reference surface;
determining a gesture location within the current 3D image based on the identified segment;
identifying a data set corresponding to the gesture location; and
adjusting an output of a display based on information in the data set.

10. The medium of claim 9, wherein calculating distances between the depth camera and 3D pixels comprises:
determining a depth of each of multiple 3D pixels in a 3D image; and
summing the determined depths.

11. The medium of claim 9, wherein the method further comprises:
continuously and repeatedly, while acquiring the stream of 3D images, performing the steps of:
identifying an increase in distance;
detecting a pause; and
defining a reference surface.

12. The medium of claim 9, wherein the method further comprises:
storing two dimensional (2D) images from a 2D camera in memory;
identifying the data set as a portion of a 2D image representing the gesture location in the physical workspace; and
directing the display to present a magnified version of the portion of the 2D image.

13. The medium of claim 9, wherein the method further comprises:
identifying a 3D coordinate of the gesture location within the physical workspace;
identifying a slice of a multi-slice scan of an object for viewing based on one dimension of the 3D coordinate, wherein each slice is a two dimensional (2D) image;
identifying the data set as an in-plane portion of the identified slice for viewing based on two dimensions of the 3D coordinate; and
directing a display to present the portion of the identified slice.

14. The medium of claim 9, wherein the method further comprises:
identifying a 3D coordinate of the gesture location within the physical workspace;
identifying a portion of a target image, the target image presented on another display within the physical workspace, for viewing based on two dimensions of the 3D coordinate;
identifying a level of magnification based on one dimension of the 3D coordinate;
contacting a server to retrieve the data set, wherein the data set comprises a high-resolution version of the portion of the target image; and
directing the display to present the high-resolution version of the portion.

15. The medium of claim 9, wherein the method further comprises:
identifying a 3D coordinate of the gesture location within the physical workspace;
identifying a portion of a target image, the target image presented on another display within the physical workspace, based on two dimensions of the 3D coordinate;
identifying the data set as an entry in a database based on the portion of the target image;
identifying a level of detail based on one dimension of the 3D coordinate; and
directing the display to present the entry in the database based on the identified level of detail.

16. The medium of claim 9, wherein:
the data set is an image of the portion, and
the method further comprises:
identifying a 3D coordinate of the gesture location within the physical workspace;
identifying a portion of physical workspace based on two dimensions of the 3D coordinate;
performing Optical Character Recognition (OCR) on the portion of the physical workspace to identify a written word within the physical workspace;
directing a projector to highlight the written word by projecting visible light onto the physical workspace; and
directing the display to present a magnified version of the portion.

17. A method comprising:
acquiring a stream of three dimensional (3D) images of a physical workspace from a depth camera;
calculating distances between the depth camera and objects represented by 3D pixels within the 3D images of the stream;
identifying an increase in distance between the objects and the depth camera over time based on the 3D pixels;
detecting a pause following the increase in distance;
defining a reference surface corresponding to a 3D image of the physical workspace during the pause,
identifying a change in distance between the objects and the depth camera for a current 3D image acquired after defining the reference surface;
identifying a segment of the current 3D image that is closer to the depth camera than the reference surface;
determining a gesture location within the current 3D image based on the identified segment;
identifying a data set corresponding to the gesture location; and
adjusting an output of a display based on information in the data set.

18. The method of claim 17, wherein calculating distances between the depth camera and 3D pixels comprises:
determining a depth of each of multiple 3D pixels in a 3D image; and
summing the determined depths.

19. The method of claim 17, further comprising:
continuously and repeatedly, while acquiring the stream of 3D images, performing the steps of:
identifying an increase in distance;
detecting a pause; and
defining a reference surface.

20. The method of claim 17, further comprising:
storing two dimensional (2D) images from a 2D camera in memory;
identifying the data set as a portion of a 2D image representing the gesture location in the physical workspace; and
directing the display to present a magnified version of the portion of the 2D image.
